(19) United States
(12) Patent Application Publication
(10) Pub. No.: US 2006/0063125 A1
(43) Pub. Date: Mar. 23, 2006

(54) Method and device for enhanced dental articulation

(76) Inventors: Timothy F. Hamilton, Griffin, GA (US); Ted Ernest Goodwin, Appleton, WI (US)

Correspondence Address: STITES & HARBISON, PLLC, 400 W MARKET ST, SUITE 1800, LOUISVILLE, KY, 40202-3352, US

(21) Appl. No.: 11/209,197

(22) Filed: Aug. 23, 2005

Related U.S. Application Data
(63) Continuation-in-part of application No. 10/420,663, filed on Apr. 22, 2003, now Pat. No. 6,932,602.

(51) Int. Cl. A61C 9/00

(52) U.S. Cl. 433/70

(57) ABSTRACT

A method for performing a dental articulation test and a related test kit are provided. In preferred embodiments, the method includes applying a first chemical component of a binary marking system to at least one tooth of a patient or articulation device. A substrate sheet that contains a coating of microcapsules disposed on at least one side thereof, with at least some of the microcapsules containing a second chemical component of the binary marking system is inserted into the patient's mouth or the articulation device. The first and second arches of the patient or articulation device are then caused to occlude over the substrate, thereby causing formation of a visible mark at the occlusion contact points. The dental articulation kit includes the substrate sheet, an applicator for applying the first chemical component of the binary marking system to teeth, and a quantity of the first chemical component of the binary marking system sufficient to apply to at least one tooth.

### RELATED APPLICATIONS

This application is a continuation of application Ser. No. 10/420,663, DENTAL ARTICULATION KIT AND METHOD, filed Apr. 22, 2003.

### BACKGROUND OF THE INVENTION

1. Field of the Invention

This invention pertains to dental articulation kits as well as methods for performing dental articulation.

2. Description of the Related Art

Dental articulation is a methodology used to determine the occlusion contact points between upper and lower teeth. Articulation is useful in a variety of dental treatments and can be used for instance, in determining the size, shape, and proper placement of bridges, caps, crowns, and filings and in observing the progress of an orthodontic treatment program. Articulation methods can be performed on the actual teeth of a patient or on a dental articulation device which, for example, consists of a model of all or a portion of a patient's oral cavity that replicates movement of the patient's jaws. These articulation devices are frequently used to help design replacements for the missing or damaged teeth of a patient and to test the fit of orthodontic appliances such as braces.

Dental articulation tests are commonly performed by inserting carbon paper between the upper and lower dental arches of the patient. The patient then bites strongly on the carbon paper to occlude the upper and lower teeth. Carbon particles adhere on the occlusal surfaces of the teeth where the upper and lower teeth are abutted. The dental practitioner can then diagnose the occlusion condition of the teeth by observing the positions and areas of the portions to which carbon particles stick.

Unfortunately, articulation tests performed using carbon paper frequently produce results that do not accurately reflect the precise occlusion contact points. For example, carbon paper articulation tests often produce false spots or false lines. Additional problems with carbon paper that detract from the accuracy of articulation tests include clumping and smudging of the carbon. These problems can be exacerbated by the saliva present in the patient's mouth.

Another problem with dental articulation tests performed using carbon paper is that the carbon does not always transfer well to a patient's teeth. As a result, a patient sometimes must bite down on the carbon paper several times in order to get good transfer of the carbon to the teeth. Often, the patient may have to grind the carbon paper between his teeth to ensure good carbon transfer.

### SUMMARY OF THE INVENTION

The invention provides a dental articulation kit and method which overcomes the problems with conventional carbon paper articulation tests as well as offers other features and advantages. In particular, according to one embodiment of the present invention, a method for dental articulation is provided with includes applying an absorbent material that includes a first chemical component of a binary marking system to a tooth of a patient. At least a portion of the first chemical component is allowed to deposit on to the tooth and at least a portion of the patient's saliva is allowed to become absorbed by said absorbent material. A substrate that includes a second chemical component of the binary marking system is inserted into the patient's mouth. The patient's teeth are then caused to occlude over the substrate thereby causing formation of a visible mark at occlusion contact points.

According to another embodiment of the present invention, a dental articulation kit is provided that includes an absorbent substrate including an absorbent material and a first chemical component of a binary marking system. The kit further includes a second substrate including a second chemical component of the binary marking system. The first and second substrates are sized for human dental articulation and the absorbent substrate is relatively more absorbent than said second substrate.

In yet another embodiment of the present invention, a method for dental articulation is provided that includes applying a first chemical component of a binary marking system to at least one tooth of a patient or articulation device. A substrate sheet that contains a coating of microcapsules disposed on at least one side thereof, with at least some of the microcapsules containing a second chemical component of the binary marking system, is inserted into the patient's mouth or the articulation device. The first and second arches of the patient or articulation device are then caused to occlude over the substrate, thereby causing formation of a visible mark at occlusion contact points.

According to a further embodiment of the present invention, a dental articulation kit is provided that includes at least one substrate having first and second sides and including a coating of a microencapsulated first binary chemical component of a binary marking system disposed on at least one of the first and second sides. The kit also includes a quantity of a second binary chemical component of the binary marking system sufficient to apply to at least one tooth of a patient or articulation device to enable dental articulation and an applicator for applying the second binary chemical component to at least one tooth of a patient or articulation device.

In another embodiment of the present invention, a method for dental articulation is provided that includes the step of applying a substrate sheet that includes a coating of microcapsules disposed on at least one side thereof to at least one tooth of a patient or articulation device. The first and second arches of the patient or articulation device are then caused to occlude over the substrate whereby at least some of the microcapsules rupture thereby releasing a material contained in the microcapsules at occlusion contact points. The release of material from the microcapsules causes light to be emitted from the tooth at the occlusion contact points.

In another embodiment, the invention provides a method in which a mixture of first and second components of a binary marking system is applied to a tooth of a patient or articulation device. The first and second components are separate in the mixture but are reactive to form a visible mark upon the application of pressure. The teeth of the patient or device are caused to occlude, thereby forming a visible mark at occlusion contact points. A kit that includes such a mixture and an applicator also falls within the purview of the invention.

In another embodiment, the first and second components of a binary marking system are applied separately to first and second contacting teeth of a patient or articulation device. In this embodiment, the first and second components are reactive to form a visible mark upon the application of pressure. The teeth of the patient or device are caused to occlude, thereby forming a visible mark at occlusion contact points. A kit that includes the first and second components and an applicator also is encompassed by the invention.

The invention further contemplates a method for dental articulation in which a light-emitting material is applied to the tooth of a patient or articulation device. First and second arches of the patient or device are caused to occlude, thereby leaving a mark at occlusion contact points. A device that comprise a substrate on which is disposed a light-emitting material that is transferable to a tooth upon the application of pressure also is encompassed by the invention. The device is useful in the practice of the foregoing method.

### BRIEF DESCRIPTION OF THE DRAWINGS

FIG. 1 is a plan view of an exemplary dental articulation kit according to the present invention.

FIG. 2 is a perspective view showing an occlusion substrate inserted between occluded upper and lower arches of a patient or dental articulation device.

FIG. 3 is a perspective view showing exemplary formation of a visible mark at the occlusion contact points on the teeth of a patient or articulation device in accordance with one embodiment of the present invention.

FIG. 4 is a plan view of an alternative embodiment of a dental articulation kit according to the invention.

### DETAILED DESCRIPTION OF THE PREFERRED EMBODIMENTS

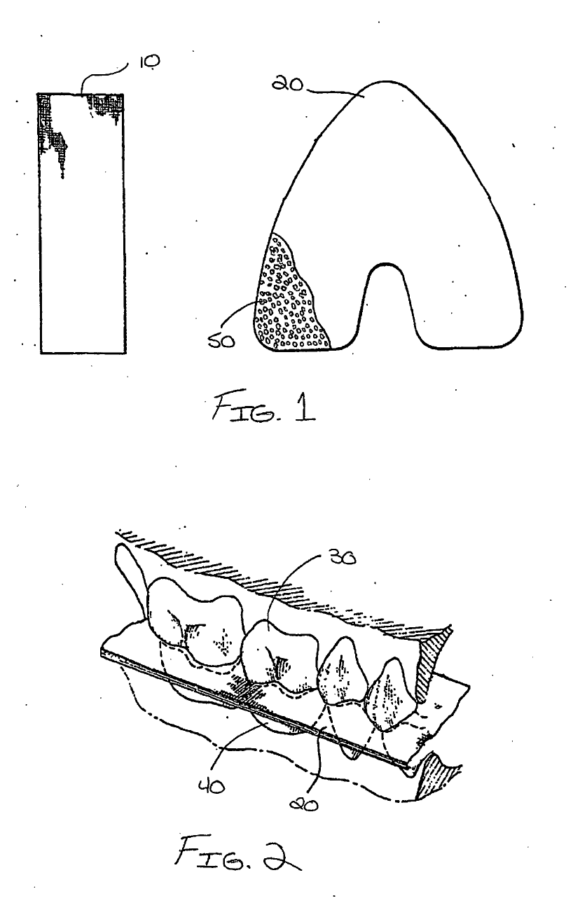

Referring now to FIG. 1 of the drawings, the illustrated kit utilizes a binary marking system consisting of first and second chemical components that produce a visible effect such as color formation when they are intermixed. It is contemplated that the “color” may be a black, gray, or other visible indicia, such as a light-emitting indicia. The illustrated kit includes an applicator substrate 10 and an occlusion substrate 20. In general, the two substrates 10, 20 are usable to situate the two components of the binary marking system in the mouth of a patient, or with respect to a dental articulation device, such that when the upper and lower teeth 30, 40 of the patient or dental articulation device occlude, the two chemicals intermix causing formation of a visible mark at the occlusion contact points on the teeth.

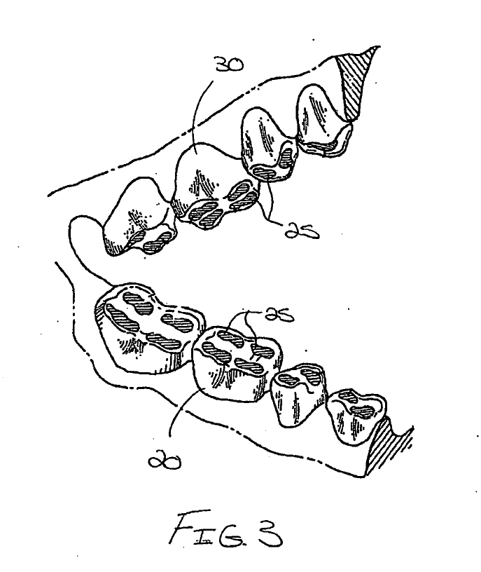

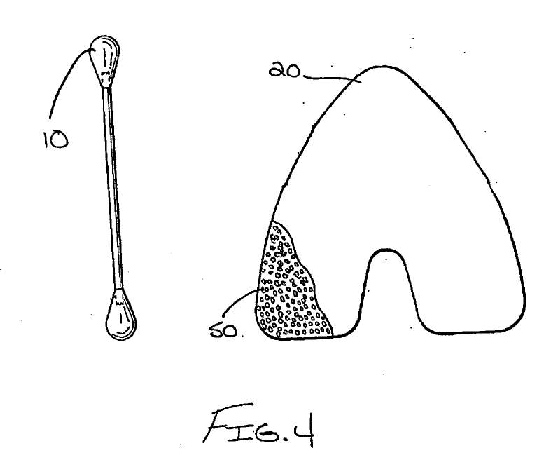

To this end, the applicator substrate 10 in the illustrated kit is useable to apply a first chemical component of the binary marking system to the teeth of the patient or articulation device on which the articulation test is to be performed. The kit can further include a quantity of the first chemical component of the binary marking system sufficient to apply to at least one tooth. In practice, the first chemical component generally will be applied to a plurality of teeth in both upper and lower dental arches, however, the present invention can be practiced in connection with only a single tooth. The occlusion substrate 20 includes the second chemical component of the binary marking system. The occlusion substrate 20 is insertable into the patient's mouth or the articulation device between the upper and lower teeth 30, 40 (see FIG. 2). When the upper and lower teeth 30, 40 of the patient or articulation device occlude over the occlusion substrate 20, the first and second chemical components intermix thereby causing formation of a visible mark at the occlusion contact points 25 (see FIG. 3).

The present invention further includes a method for performing a dental articulation test that is not limited to any particular articulation kit. According to one embodiment of the method of the present invention, the first chemical component is simply applied to at least one tooth of a patient or dental articulation device. A substrate sheet that contains a second chemical component of the binary marking system (e.g., the occlusion substrate 20) is inserted into the patient's mouth or articulation device such as shown in FIG. 2. The first and second arches of said patient or articulation device are then caused to occlude over said substrate, thereby causing formation of a visible mark at occlusion contact points 25 (see, e.g., FIG. 3).

While the embodiment of the invention illustrated in FIG. 1 utilizes an applicator substrate 10, which for example can consist of filter paper, to apply one of the components of the binary marking system to teeth, it will be appreciated that any suitable applicator device could be used in the kit and method of the present invention. For example, the applicator could consist of a brush, swab, or spraying device. Advantageously, the applicator used to apply the first chemical to the teeth can include an absorbent material such as in the form of an absorbent substrate, pad, or swab. When the kit or method of the present invention is used on the teeth of a patient, this absorbent material can be used to absorb at least some of the saliva present on and/or around the patient's teeth. The removal of the saliva helps to enhance the formation of the visible mark on the occlusion points thereby improving the test results.

To simplify performance of the test, one or both of the substrates 10, 20 can be sized or configured specifically for dental articulation tests. For example, in the illustrated embodiment, the occlusion substrate 20 has a generally horseshoe shaped configuration that conforms to the shape of a human dental arch. The configuration is not critical, but to the contrary any substitutes sized for human dental articulation may be employed. Any suitable substrate, such as paper, silk, foil, or the like may be employed in conjunction with the invention.

According to one embodiment of the invention, the binary marking system is pressure sensitive, by which is contemplated that the application of pressure beyond ordinarily ambient pressure is required to cause formation of a visible mark. In particular, a coating of pressure-rupturable microcapsules 50 containing the second chemical component of the binary marking system can be provided on at least one surface of the occlusion substrate 20 as shown in FIG. 1. These microcapsules 50 are designed to rupture and release the second chemical component when the teeth of a patient or articulation device occlude over the occlusion substrate 20. Once released from the microcapsules 50, the second chemical intermixes with the first chemical that was applied to the teeth. This results in a chemical reaction that produces the color formation or other visible mark formation. If a coating of microcapsules 50 is provided on both the upper and lower surfaces of the occlusion substrate 20, the occlusion substrate can be used to identify the occlusion contact points on both the upper and lower dental arches.

One example of a pressure sensitive binary marking system suitable for use in the present invention is the system used in carbonless paper. For instance, carbonless paper such as UltraMark CB 16.8 lb. white carbonless paper, which is available from Appleton Papers Inc. of Appleton, Wis., is one example of a substrate suitable for use as the occlusion substrate. Such sheets of carbonless paper include pressure-rupturable microcapsules containing a color forming material. A solvent can be used to facilitate contact of the first chemical compound with the second chemical compound of the binary marking system. Examples of solvents suitable for use in microcapsules on the occlusion substrate include ethyldiphenylmethane (U.S. Pat. No. 3,996,405); benzylxylene (U.S. Pat. No. 4,130,299); alkyl biphenyls such as propylbiphenyl (U.S. Pat. No. 3,627,581) and butylbiphenyl (U.S. Pat. No. 4,287,074); dialkyl phthalates in which the alkyl groups thereof have from 4 to 13 carbon atoms, e.g. dibutyl phthalate, dioctylphthalate, dinonyl phthalate and ditridecylphthalate; 2,2,4-trimethyl-1,3-pentanediol diisobutyrate (U.S. Pat. No. 4,027,065); C.sub.10-C.sub.14 alkyl benzenes such as dodecyl benzene; alkyl or aralkyl benzoates such as benzyl benzoate; alkylated naphthalenes such as dipropylnaphthalene (U.S. Pat. No. 3,806,463); partially hydrogenated terphenyls; high-boiling straight or branched chain hydrocarbons; and mixtures of the above. Vegetable oils, esters of vegetable oils and mixtures that include such vegetable oils can also be advantageous used. Vegetable oil based solvent systems for applications involving pressure-rupturable microcapsules are described in U.S. Pat. Nos. 5,177,051; 5,281,266; 5,464,803; 5,472,489; 5,476,829; 5,605,874; and 6,310,002.

A chromogenic material preferably is included in the microcapsules on the occlusion substrate along with any of the above solvents. The solvent in the microcapsules facilitates the transfer of the chromogenic material to the acidic developer material which is the other component of the binary marking system.

The chromogen or chromogenic materials are electron donating dye precursors also known as colorformers. The chromogenic materials are typically colorless or lightly colored in one state, and express an observable color when contacted with an acidic developer material. These colorformers include phthalide, leucauramine and fluoran compounds. Chromogenic materials also include Crystal Violet Lactone (3,3-bis(4-dimethylaminophenyl)-6-dimethylaminophthalide, U.S. Pat. No. RE. 23,024); phenyl-, indol-, pyrrol- and carbazol-substituted phthalides (for example, in U.S. Pat. Nos. 3,491,111; 3,491,112; 3,491,116; 3,509,174); nitro-, amino-, amido-, sulfonamido-, aminobenzylidene-, halo-, anilino-substituted fluorans (for example, in U.S. Pat. Nos. 3,624,107; 3,627,787; 3,641,011; 3,642,828; 3,681,390); spiro-dipyrans (U.S. Pat. No. 3,971,808); and pyridine and pyrazine compounds (for example, in U.S. Pat. Nos. 3,775,424 and 3,853,869). Other eligible chromogenic materials include: 3-diethylamino-6-methyl-7-anilino-flouran (U.S. Pat. No. 3,681,390); 2-anilino-3-methyl-6-dibutylamino-fluoran (U.S. Pat. No. 4,510,513) also know as 3-dibutylamino-6-methyl-7-anilino-fluoran; 3-dibutylamino-7-(2-chloroanilino)fluoran; 3-(N-ethyl-N-tetrahydrofurfurylamino)-6-methyl-7-3-5′6-tris(di-methylamino)spiro[9H-fluorene-9′1(3′H)-isobenzofuran]-3′-one; 7-(1-ethyl-2-methylindol-3-yl)-7-(4-diethylamino-2-ethoxyphenyl)-5,7-dihydrofuro[3,4-b]pyridin-5-one (U.S. Pat. No. 4,246,318); 3-diethylamino-7-(2-chloroanilino) fluoran (U.S. Pat. No. 3,920,510); 3-(N-methylcyclohexylamino)-6-methyl-7-anilino-fluoran (U.S. Pat. No. 3,920,510); 3-(N-methylcyclohexylamino)-6-methyl-7-anilino-fluoran (U.S. Pat. No. 3,959,571); 7-(1-octyl-2-methylindol-3-yl)-7-4-(4-diethylamino-2-ethoxy-phenyl)-5,7-dihydrofuro [3,4-b] pyridin-5-one; 3-diethylamino-7,8-benzofluoran; 3,3-bis(1-ethyl-2-methylindol-3-yl) phthalide; 3-diethylamino-7-anilino-fluoran; 3-diethylamino-7-benzylamino-fluoran; 3′-phenyl-7-dibenzylamino-2,2′-spiro-di-[2H-1-benzo-pyran]; 6′[ethyl(3-methylbutyl)amino]-3′-methyl-2′ (phenylamino)-spiro[isobenzofuran-1(3H), 9′-[9H]xanthen]-3-one; 6-(dimethylamino-3,3-bis(4-(dimethylamino)phenyl)-1(3H)-isobenzofuranone (crystal violet lactone); 3-diethylamino-6-methyl-7-(2,4-dimethylphenyl)aminofluoran and mixtures of any of the foregoing. The or crystalline forms, of some of the fluorans, where such are known, are equally functional.

Opposite positioning of the binary components from the configuration normally employed in connection with carbonless paper can also be useful. Such variation in this application can involve microencapsulating the solvent and acidic developer and coating onto the occlusion substrate. If the acidic developer is selected to be liquid, the developer can perform the function of the solvent as well. The chromogenic material in such variation can be applied in its colorless form to the teeth of the patient, or to the absorbent material for application to the patient's teeth. The occlusion substrate is then relied upon to transfer the developer material to colorize the chromogen when pressure is applied sufficient to rupture the microcapsules. For instance, the occlusion substrate can be coated with developer material. A common example of such arrangement is carbonless CF paper.

The chromogen could be applied as a solution directly to the teeth of the patient or via the absorbent material. It is possible, though not preferred, to forego the capsules altogether in such a variation. The use of microencapsulated chromogen is believed to provide a higher level of definition of the dental occlusion contact points. A liquid solution that eliminates the occlusion substrate could involve forming a slurry or paste or other thixotropic mixture of chromogen suspended in a waxy or semi-liquid developer material. The binary marking system can be formed as such a coating paste or thixotropic solution. Such a composition can be prepared which includes a fine dispersion of the chromogenic material, encapsulated or unencapsulated in a base of acidic clay with optional other fillers, waxes, or binders to form a paste. A common example of such compositions is the slurries used in forming thermally imaged papers or carbonless self-contained dispersions. The materials would be selected to cause formation of a visible mark at ambient temperatures with the frictional contact of the teeth sufficient to enable the formation of a visible mark when the capsules are ruptured or pressure applied to the paste to facilitate intimate reactive contact between developer and chromogeneic material. Optionally, chromogenic material can be encapsulated together with solvent and formed into a slurry suspension in a liquid or semiliquid developer material. It is also possible to form two populations of microcapsules, with the first population encapsulating chromogenic material and the second population encapsulating developer. A slurry mixture of such capsules could be directly coated to the surface of the teeth. The microcapsules thus applied to the teeth can optionally contain solvent and chromogenic material. The occlusion substrate in such variation contains a coating of a developer material such as an acidic clay or resin. More generally, any configuration whereby a visible effect is formed, preferably only upon the application of pressure, may be employed in conjunction with the invention.

The microcapsules can be prepared by processes well known in the art such as from gelatin as disclosed in U.S. Pat. Nos. 2,800,457 and 3,041,289; or, more preferably, from urea-formaldehyde resin and/or melamine-formaldehyde resin as disclosed in U.S. Pat. No. 4,001,140; 4,081,376; 4,089,802; 4,100,103; 4,105,823; 4,444,699; or 4,552,811.

When using such carbonless paper as the occlusion substrate, the first chemical of the binary marking system which is applied using the applicator substrate can consist of any material that combines with the material used in the microcapsules. While the amounts used should be small, if the first chemical component is going to be applied to the teeth of a patient as opposed to a dental articulation device, it may be desirable to use an aqueous solution of dentally compatible organic acid such as pectin or other Lewis acid.

Other chemicals that could be used include clays; treated clays (U.S. Pat. Nos. 3,622,364 and 3,753,761); aromatic carboxylic acids such as salicylic acid; derivatives of aromatic carboxylic acids and metal salts thereof (U.S. Pat. No. 4,022,936); phenolic developers (U.S. Pat. No. 3,244,550); acidic polymeric material such as phenol-formaldehyde polymers, etc. (U.S. Pat. Nos. 3,455,721 and 3,672,935); and metal-modifed phenolic resins (U.S. Pat. Nos. 3,732,120; 3,737,410; 4,165,102; 4,165,103; 4,166,644 and 4,188,456). Additional details regarding the pressure sensitive binary marking systems used in carbonless paper are provided in U.S. Pat. Nos. 2,730,456; 3,565,666; 3,955,026 and 4,596,996. The disclosures of all of the mentioned patents are incorporated herein by reference. The chemistries employed in some patents are not contemplated as exclusive, but to the contrary any binary marking system that includes first and second reactants that combine to form a visible indicia may be used in conjunction with the invention.

While an exemplary embodiment of the present invention has been described in relation to a binary marking system such as is used in carbonless paper, it will be understood that the present invention is not limited to such a binary marking system. For example, the chemical component provided on the occlusion substrate does not have to be microencapsulated. Moreover, the placement of the two chemical components could be reversed with the microencapsulated component being applied to the teeth. Thus it will be appreciated that any suitable binary marking system consisting of first and second components that produce a visible effect when they are intermixed can be used.

In accordance with an alternative embodiment of the present invention, the dental articulation test method and related kit can be modified such that light is emitted from one or more teeth at the occlusion contact points. This embodiment utilizes a binary system comprising first and second chemical components that produce a light emitting or luminous effect when intermixed. The light-emitting property may be visible in the absence of electromagnetic radiation or upon exposure to electro magnetic radiation (e.g. “black” light). Specifically, a first chemical component of the binary luminous marking system may be applied to the teeth of a patient or articulation device using any suitable applicator such as, for example, a substrate, swab, or spray. In turn, the occlusion substrate carries the second component of the binary system. This component on the occlusion substrate may or may not be microencapsulated. One example of a suitable chemical compound for use on the occlusion substrate is fluorecene, although other chemicals could also be used. When the teeth of the patient or dental articulation device occlude over the substrate, luminous markings adhere to the teeth at the occlusion contact points. A black light may be used to assist in viewing the luminous markings on the teeth.

Alternatively, the occlusion substrate can simply include a coating of a light emitting or luminous material. Again, the material may be light emitting in the absence of electromagnetic radiation or upon exposure to electromagnetic radiation. Preferably, but not necessarily, the light-emitting material is microencapsulated. When the teeth of the patient or dental articulation device occlude over the substrate, the microcapsules rupture and release the light emitting material, which then adheres to the teeth at the occlusion contact points. The luminous material also may be coated onto the occlusion substrate without the use of microcapsules. Additionally, a second chemical component may be applied to the teeth to assist in the transfer of the light emitting or luminous material to the teeth. In accordance with another embodiment, the light-emitting material may be applied directly to a tooth of a patient or articulation device, with or without the use of a substrate. First and second arches of the patient or device are caused to occlude, where upon a mark is formed at occlusion contact points. The light-emitting material may be provided on a suitable substrate or without a substrate (e.g. by swabbing or spraying onto the tooth). If used, the substrate may be a thin substrate (such as paper or film) having light-emitting material disposed on one or both sides thereof.

It is thus seen that the invention provides methods and kits useful in conjunction with dental articulation.

All references cited herein are hereby incorporated by reference.

All methods described herein can be performed in any suitable order unless otherwise indicated herein or otherwise clearly contradicted by context. The use of any and all examples, or exemplary language provided herein does not pose a limitation on the scope of the invention unless otherwise claimed. No language in the specification should be construed as indicating any non-claimed element as essential to the practice of the invention. The terms “first and second” when describing components in the claims should be construed only with reference to the claim in which such terms are used, or in a prior claim from which such claim depends, and it is not necessarily intended for these terms to be used consistently from one group of claims to another.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. (canceled)

2. A dental articulation kit comprising:
a substrate, said substrate being sized for dental articulation; and
a coating of microcapsules disposed on at least one surface of said substrate, said microcapsules containing a phosphorescent chemical.

3. The dental articulation kit as in claim 2 wherein said substrate comprises carbon articulation paper.

4. The dental articulation kit as in claim 2 wherein said substrate comprises wax articulation paper.

5. The dental articulation kit as in claim 2 wherein said phosphorescent chemical is capable of adhering to a tooth of a patient.

6. The dental articulation kit as in claim 2 wherein said phosphorescent chemical is capable of adhering to a tooth of a dental articulation device.

7. The dental articulation kit as in claim 2 wherein said microcapsules are of a strength so as to not rupture with ambient pressure of the upper and lower arches of a patient's mouth or of a dental articulation device.

8. The dental articulation kit as in claim 2 wherein said microcapsules rupture when biting pressure is applied by the patient's mouth or by a dental articulation device.

9. The dental articulation kit as in claim 8 wherein said microcapsules rupture occlusion points of the patient's teeth.

10. A method for dental articulation comprising,
inserting into a patient's mouth or dental articulation device a substrate sheet having disposed on at least one side thereof a coating of microcapsules containing a phosphorescent chemical; and
causing first and second arches of said patient's mouth or said articulation device to occlude over said substrate sheet at a plurality of occlusion points, thereby causing a visible phosphorescing mark at each occlusion contact point.

11. A method according to claim 10 wherein said substrate sheet has coatings of said microcapsules containing a phosphorescent coating disposed on each side of said substrate sheet.

12. A method according to claim 10 wherein said microcapsules rupture when biting pressure is applied by said patient's mouth or by said dental articulation device.

13. A method according to claim 10 wherein said phosphorescent chemical is capable of adhering to the teeth of said patient.

14. A method according to claim 10 wherein said phosphorescent chemical is capable of adhering to the teeth of said dental articulation device.

15. A dental articulation kit comprising:
a substrate, said substrate being sized for dental articulation; and
a coating of a phosphorescent chemical disposed on at least one surface of said substrate.

16. A dental articulation kit as in claim 15 wherein said substrate comprises wax articulation paper.

17. A dental articulation kit as in claim 15 wherein said substrate comprises carbon articulation paper.

18. A dental articulation kit as in claim 15 wherein said phosphorescent chemical is capable of adhering to the tooth of a patient.

19. A dental articulation kit as in claim 15 wherein said phosphorescent chemical is capable of adhering to the tooth of a dental articulation device.

20. A dental articulation kit as in claim 15 wherein said phosphorescent chemical releases from said substrate upon the application of biting pressure by the patient's teeth.

21. A dental articulation kit as in claim 15 wherein said phosphorescent chemical releases from said substrate upon the application of biting pressure by the dental articulation device.

22. A dental articulation kit as in claim 20 wherein said phosphorescent chemical releases from said substrate at occlusion contact points.

23. A dental articulation kit as in claim 21 wherein said phosphorescent chemical releases from said substrate at occlusion contact points.

24. A method for dental articulation, comprising:
inserting into a patient's mouth or dental articulation device a substrate sheet having disposed on at least one side thereof a coating of a phosphorescent chemical; and
causing first and second arches of said patient's mouth or of said dental articulation device to occlude over said substrate sheet at a plurality of occlusion points, thereby causing a visible phosphorescing mark at each occlusion contact point.

25. A method according to claim 24 wherein said substrate sheet has said phosphorescent coating disposed on each side of said substrate sheet.

26. A method according to claim 24 wherein said phosphorescent chemical is capable of adhering to the teeth of said patient.

27. A method according to claim 24 wherein said phosphorescent chemical is capable of adhering to the teeth of said dental articulation device.

28. A dental articulation kit, comprising:
a substrate, said substrate being sized for dental articulation;
a coating of a first set of microcapsules containing a first light-emitting chemical disposed on at least one surface of said substrate; and
a coating of at least a second set of microcapsules containing a second light-emitting chemical disposed on at least said one surface of said substrate.

29. The dental articulation kit as in claim 28 wherein said substrate comprises carbon articulation paper.

30. The dental articulation kit as in claim 28 wherein said substrate comprises wax articulation paper.

31. The dental articulation kit as in claim 28 wherein said first light-emitting chemical is of a first color.

32. The dental articulation kit as in claim 28 wherein said second light-emitting chemical is of a second color.

33. The dental articulation kit as in claim 28 wherein said first light-emitting chemical of a first color is capable of adhering to the tooth of a patient.

34. The dental articulation kit as in claim 27 wherein said second light-emitting chemical of a second color is capable of adhering to the tooth of a patient.

35. The dental articulation kit as in claim 28 wherein said first light-emitting chemical is capable of adhering to the tooth of a dental articulation device.

36. The dental articulation kit as in claim 28 wherein said second light-emitting chemical is capable of adhering to the tooth of a dental articulation device.

37. The dental articulation kit as in claim 28 wherein said first set of microcapsules rupture when a first biting pressure is applied by the patient's mouth or by a dental articulation device.

38. The dental articulation kit as in claim 28 wherein said second set of microcapsules rupture when a second biting pressure is applied by the patient's mouth or by a dental articulation device.

39. The dental articulation kit as in claim 28 wherein said first microcapsules rupture at occlusion points of said first biting pressure.

40. The dental articulation kit as in claim 28 wherein said second microcapsules rupture at occlusion points of said second biting pressure.

41. A method for dental articulation, comprising:
inserting into a patient's mouth or dental articulation device a substrate sheet having disposed on at least one side thereof a first coating of microcapsules containing a first light-emitting chemical of one color and a second coating of microcapsules containing a second light-emitting chemical of second color; and
causing first and second arches of said patient's mouth or said articulation device to occlude over said substrate sheet at a plurality of occlusion points, thereby causing visible marks of first and second colors at each occlusion contact point.

42. A method according to claim 41 wherein said substrate sheet has said first coating of microcapsules and said second coating of microcapsules disposed on each side of said substrate sheet.

43. A method according to claim 41 wherein said first and second light-emitting chemicals adhere to said patient's teeth.

44. A method according to claim 41 wherein said first and second light-emitting chemicals adhere to the teeth of said dental articulation device.

45. A dental articulation kit, comprising:
a substrate, said substrate being sized for dental articulation;
a coating of a first set of microcapsules containing a first phosphorescent chemical disposed on at least one surface of said substrate; and
a coating of at least a second set of microcapsules containing a second phosphorescent chemical disposed on at least one said at least one surface of said substrate.

46. The dental articulation kit as in claim 45 wherein said substrate comprises carbon articulation paper.

47. The dental articulation kit as in claim 45 wherein said substrate comprises wax articulation paper.

48. The dental articulation kit as in claim 45 wherein said first phosphorescent chemical is of a first color.

49. The dental articulation kit as in claim 45 wherein said second phosphorescent chemical is of a second color.

50. The dental articulation kit as in claim 45 wherein said first phosphorescent chemical of a first color is capable of adhering to the tooth of a patient.

51. The dental articulation kit as in claim 45 wherein said second phosphorescent chemical of a second color is capable of adhering to the tooth of a patient.

52. The dental articulation kit as in claim 45 wherein said first phosphorescent chemical is capable of adhering to the tooth of a dental articulation device.

53. The dental articulation kit as in claim 45 wherein said second phosphorescent chemical is capable of adhering to the tooth of a dental articulation device.

54. The dental articulation kit as in claim 45 wherein said first set of microcapsules rupture when a first biting pressure is applied by the patient's mouth or by a dental articulation device.

55. The dental articulation kit as in claim 45 wherein said second set of microcapsules rupture when a second biting pressure is applied by the patient's mouth or by a dental articulation device.

56. The dental articulation kit as in claim 45 wherein said first microcapsules rupture at occlusion points of said first biting pressure.

57. The dental articulation kit as in claim 45 wherein said second microcapsules rupture at occlusion points of said second biting pressure.

58. A method for dental articulation, comprising:
inserting into a patient's mouth or a dental articulation device a substrate sheet having disposed on at least one side thereof a first coating of microcapsules containing a first phosphorescent chemical of one color and a second coating of microcapsules containing a second phosphorescent chemical of second color; and
causing first and second arches of said patient's mouth or said articulation device to occlude over said substrate sheet at a plurality of occlusion points, thereby causing visible marks of first and second colors at each occlusion contact point.

59. A method according to claim 58 wherein said substrate sheet has said first coating of microcapsules and said second coating of microcapsules disposed on each side thereof.

60. A method according to claim 58 wherein said first and second phosphorescent chemicals adhere to the teeth of said patient.

61. A method according to claim 58 wherein said first and second phosphorescent chemicals adhere to the teeth of said dental articulation device.
